(19) United States
(12) Patent Application Publication
(10) Pub. No.: US 2015/0046201 A1
(43) Pub. Date: Feb. 12, 2015

(54) Travel Booking Platform

(71) Applicant: Amgine Technologies Limited, Concord (CA)

(72) Inventors: Harold Roy Miller, Toronto (CA); L. James Valverde, JR., Washington, DC (US); Jonathan David Miller, Toronto (CA)

(21) Appl. No.: 14/453,420

(22) Filed: Aug. 6, 2014

Related U.S. Application Data
(60) Provisional application No. 61/862,850, filed on Aug. 6, 2013.

(51) Int. Cl. G06Q 10/02; G06Q 30/06

(52) U.S. Cl. CPC G06Q 10/02; G06Q 30/0609
USPC 705/5

(57) ABSTRACT

A method for guaranteeing a price of an itinerary is disclosed herein. The method comprises receiving travel attributes from a customer. Based on the travel attributes, one or more itineraries can be generated. The itineraries can be provided to the customer along with options to lock the price of the itineraries for a predetermined time in consideration of a payment. The payment for locking the price for a selected itinerary may be received from the customer. Upon making the payment, the customer may be able to purchase the itinerary at the price within the predetermined time.

### CROSS-REFERENCE TO RELATED APPLICATIONS

The present utility patent application is related to and claims priority benefit of the U.S. provisional application No. 61/862,850, filed on Aug. 6, 2013 under 35 U.S.C. 119(e), which is incorporated herein by reference for all purposes to the extent that such subject matter is not inconsistent herewith or limiting hereof.

### TECHNICAL FIELD

The present disclosure relates generally to methods and systems for booking travel and more particularly to methods and systems for booking travel itineraries with a cancelation or modification option.

### BACKGROUND

Itinerary pricing may depend on numerous factors, of which the two most important may be the time of departure and whether reservations can be refunded. Typically, earlier and nonrefundable reservations are better priced. However, such reservations require preliminary planning, which is not always possible, especially in a business environment. Additionally, browsing through available itineraries and the selection of an itinerary may take some time. In some cases, when the itinerary is selected, it may be no longer available or only available at a higher price.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for guaranteeing a price of an itinerary. An example system for guaranteeing a price of an itinerary comprises a processor and a database communicatively coupled to the processor. The processor may be configured to receive one or more travel attributes from a customer. Based on the one or more travel attributes, one or more itineraries may be generated. An itinerary may include a plurality of itinerary items, for example, flights, hotel and car reservations, transfers, and so forth. The itineraries may be provided to the customer with an option to lock the price of the one or more itineraries for a predetermined period of time. A locking request to lock a price of a selected itinerary may be received from the customer. The customer may be charged for locking the price. In some embodiments, the customer may pay required to prepay the price of the itinerary. In some embodiments, the payment amount may depend on a period of time selected by the customer for locking the price of the itinerary.

Upon receipt of the payment, the price of the selected itinerary may be locked. For this purpose, the system for guaranteeing a price of an itinerary may purchase the itinerary at original price and hold it for the predefined period of time. When the period of time elapses, the itinerary may be considered purchased by the customer. If the customer has not yet paid the price of the itinerary, a payment may be received from the customer. If the customer cancels the lock during the period of time, an extra charge for cancellation may be collected.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for guaranteeing a price of an itinerary can be implemented.

FIG. 2 is a block diagram showing a system for guaranteeing a price of an itinerary.

FIG. 3 illustrates procedures associated with an itinerary generation based on input of a customer.

FIG. 4 illustrates procedures associated with selling a locked itinerary to a customer.

FIG. 5 illustrates procedures associated with cancelling an itinerary upon request of a customer.

FIG. 6 is a process flow diagram showing a method for guaranteeing a price of an itinerary.

FIG. 7 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Planning travel may be difficult and time-consuming. Purchasing an entire itinerary (e.g., flight ticket, hotel reservation, and car rental) may be complicated because after a certain time and while other itineraries are being reviewed, some items of the reviewed itineraries may be no longer available or unavailable at the quoted price.

Another aspect of the present disclosure is related to possible savings and losses associated with early bookings and subsequent cancellations. Pricing schemes for air fares, hotels, car rentals, and other travel-related services may allow significant savings in case of an early booking. However, the longer the period before a planned departure date, the more probable is a change in plans, which can result in a cancellation or a modification of the itinerary. Cancelling or modifying the itinerary may result in losses up to 100% of the money paid.

Methods and systems described herein allow locking a price of an itinerary for a certain period of time in consideration of a payment. The itineraries may be searched based on travel attributes/requirements received from a customer and/or data retrieved from various sources, for example, social networks, travel history of the customer, and the like. Itineraries may be generated according to the travel attributes. The itineraries may be provided to the customer along with an option to lock the price of the itinerary for a certain period of time. To use the option, the customer may be asked to make a payment. By making the payment, the customer ensures that the itinerary is still available at the quoted price within the period of time. Upon receipt of the payment from the customer, the system may purchase the itinerary and hold it until the customer purchases the itinerary. When the customer purchases the itinerary, the itinerary is sold to the customer at the quoted price. Additionally, the customer may be provided with an option to modify the itinerary at an extra charge.

In some embodiments, in order to lock the itinerary, the system may charge the price of the itinerary and a payment for an option to otherwise modify the itinerary later. Without this payment, the itinerary may be nonrefundable or allow no modifications. Upon receiving a cancel/modify request, the system may refund the amount paid or modify the itinerary at an additional charge.

Customer historical data may be stored in a database. The historical data may be processed by the system to estimate the probability of a purchase or a cancellation/modification of the itinerary by the customer. Payments and/or extra charges may be adjusted based on the probability.

In some embodiments, historical data associated with all customers may be processed to adjust payments and/or extra charges of the customers.

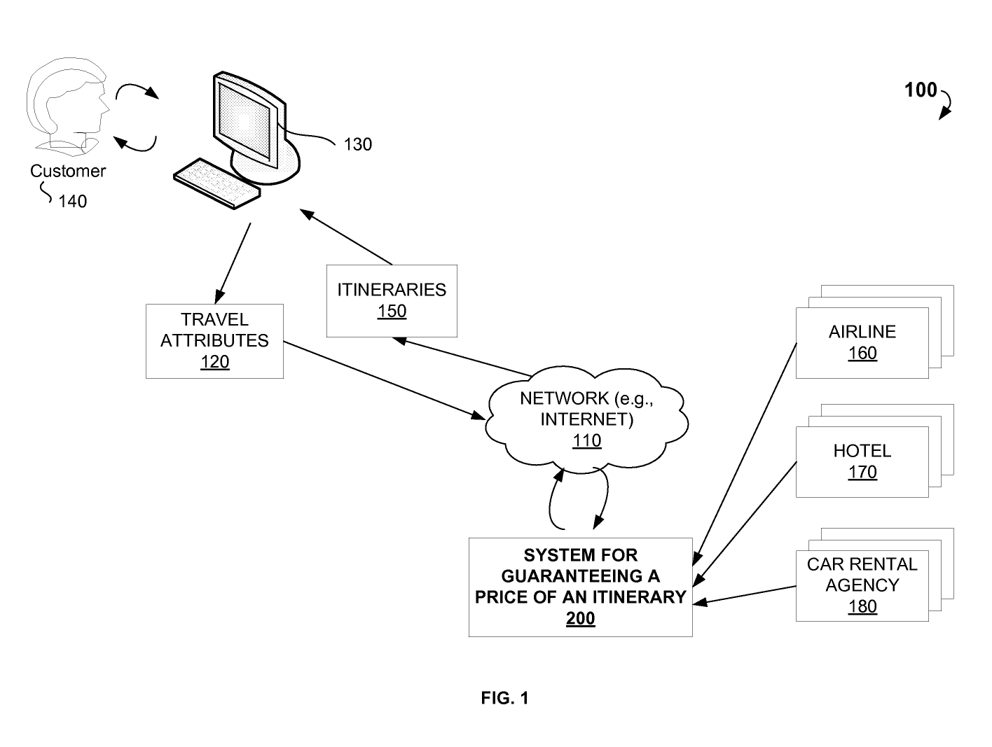

FIG. 1 illustrates an environment 100 within which the systems and methods for guaranteeing a price of an itinerary can be implemented, in accordance to some embodiments. Guaranteeing itinerary prices may be performed by a system 200 for guaranteeing a price. The system 200 may include a server-based distributed application; thus, it may include a central component residing on a server and one or more client applications residing on one or more user devices 130 and communicating with the central component via a network 110.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The customer may communicate with the system 200 for guaranteeing a price via a client application available though a client device 130. In still other embodiments, the system 200 may be a cloud-based application with the central component residing on a server and accessible via a web browser on the client device 130.

The client device 130 may include a Graphical User Interface (GUI) for displaying the user interface associated with the system 200. In a typical GUI, instead of offering only text menus or requiring typed commands, the system 200 may present graphical icons, visual indicators, or special graphical elements called widgets that may be utilized to allow a customer 140 to interact with the system 200. The client device 130 may be configured to utilize icons used in conjunction with text, labels, or text navigation to fully represent the information and actions available to the customer 140.

The client device 130 may include a mobile telephone, a computer, a lap top, a smart phone, a tablet personal computer (PC), a wearable device, an eyeglass device, and so forth.

The central component of the system 200 may receive travel attributes 120 from the customer 140 and/or other customer data from various sources, which may include online directories, social networks, blogs, travel history, and so forth. The travel attributes 120 and other customer data may be received over the network 110.

The travel attributes 120 may be obtained by analyzing text, speech, and/or other data. The analysis may determine travel attributes 120, such as travel dates, desired locations, desired transportation, accommodation classes, and so forth. Based on the travel attributes 120, the system 200 may generate one or more itineraries 150 using data received from airlines 160, hotels 170, car rental agencies 180, and other sources. The itineraries 150 may comprise various items (for example, one or more flights, rental cars, hotel rooms, and so forth). The items of each the itineraries 150 may be searched and adjusted by the system 200. The itineraries 150 may be offered to the customer 140 as a package. In such a way, time for planning a trip and searching various items may be reduced. Additionally, since the itinerary 150 may be offered as a package, the price for the whole package may also be lower compared to the individual items of the itinerary 150 bought separately.

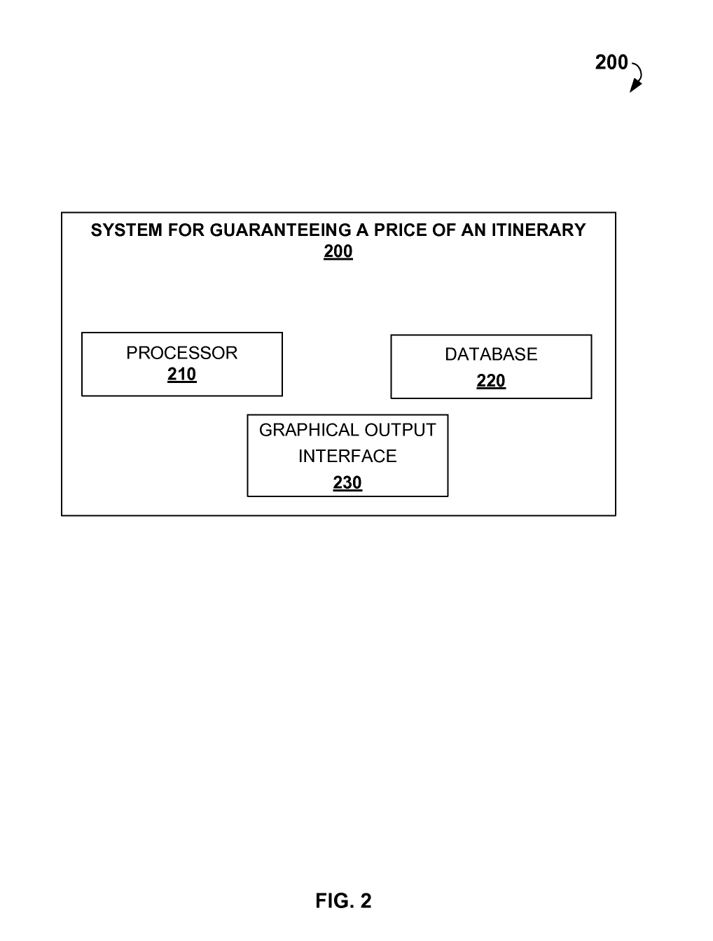

FIG. 2 is a block diagram showing various modules of the system 200 for guaranteeing a price of an itinerary, in accordance with certain embodiments. The system 200 may comprise a processor 210, a database 220, and an optional graphical user interface 230. The processor 210 may include a programmable processor, such as a microcontroller, central processing unit (CPU), and so forth. In other embodiments, the processor 210 may include an application-specific integrated circuit (ASIC) or programmable logic array (PLA), such as a field programmable gate array (FPGA), designed to implement the functions performed by the system 200. Thus, the processor 210 may receive one or more travel attributes from a customer. The travel attributes may be provided via the GUI 230 of a client application installed on the client device of the customer or via a web page associated with the system 200. The travel attributes may include various requirements and preferences of the customer for the travel being organized. Thus, as the travel attributes, the customer may specify preferred departure and arrival dates, destination country and city, desired flight class, additional requirements (e.g., a dietary meal, special needs, and so forth), hotel preferences, car preferences, and the like. Based on the travel attributes and further data retrieved by the system 200, the processor 210 may generate one or more itineraries and provide them to the customer. The processor 210 provides the itineraries with an option to lock some of the itineraries for a predefined period of time (for example, 15 minutes, 1 hour, 24 hours, and so forth). The customer may desire to guarantee that some of the provided itineraries are available at the provided price after an amount of time required to make a decision or to review other itineraries. The option to lock itineraries gives the customer such an opportunity in consideration for a payment. When a customer selects an itinerary he wants to lock, the processor 210 receives a locking request and requests a payment for locking the selected itinerary at the specified price. When the payment is received by the processor 210, the processor locks the selected itinerary. The database 220 may be configured to store the travel attributes, customer preferences, historical data of the customer, and so forth.

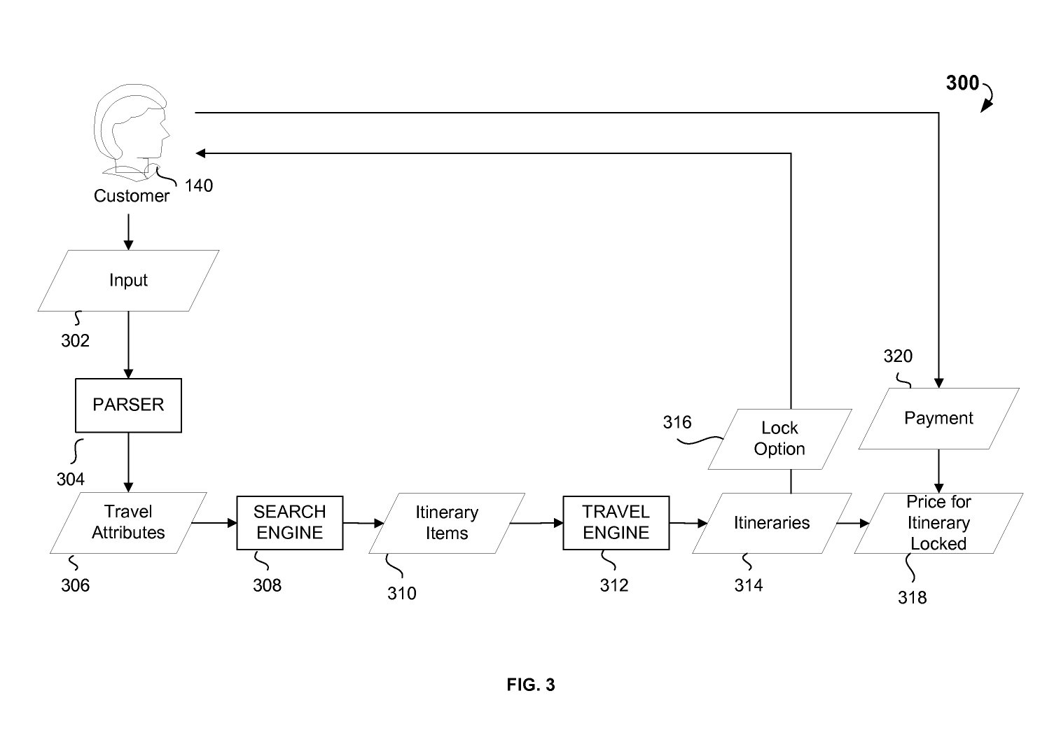

FIG. 3 shows receiving input 302 from the customer 140, in accordance with some example embodiments. The input 302 may be parsed by a parser 304 to extract travel attributes 306. The travel attributes 306 may be used by a search engine 308 to search for appropriate itinerary items 310. On some embodiments, the parser 304 may also receive and analyze data (not shown) related to the customer that is retrieved from social networks and other online resources. The data may be used by the search engine 308 together with the travel attributes 306 for itinerary search.

Based on the itinerary items 310, a travel engine 312 may generate one or more itineraries 314. The itineraries 314 may be provided to the customer 140. The provided itineraries 314 may have a lock option 316 to hold some of the itineraries 314 for a certain time. If the customer 140 desires to be able to purchase one of the itineraries 314 selected by the customer 140 later with at the same price, the customer 140 may make a payment 320 in consideration of locking the price for future purchase.

When the payment 320 is received from the customer 140, the selected itinerary may be purchased by the system 200. In some embodiments, the payment 320 may be collected together with the price of the itinerary 318. The customer 140 may purchase the selected itinerary at the price during a predetermined time.

In some embodiments, the amount of payment may 320 depend on the predetermined time for which the price is locked. For example, the payment 320 for locking an itinerary price for an hour may be lower than the payment 320 for locking the itinerary price for a day.

In some cases, the customer 140 may reject the itinerary with the locked price and, optionally, introduce some adjustments to the travel attributes 306. Based on the adjustments if any, the system 200 may generate other itineraries for the customer 140. If the customer 140 is satisfied with the offered itineraries, he may pay for the modified itineraries and, in some embodiments, be charged a modification fee.

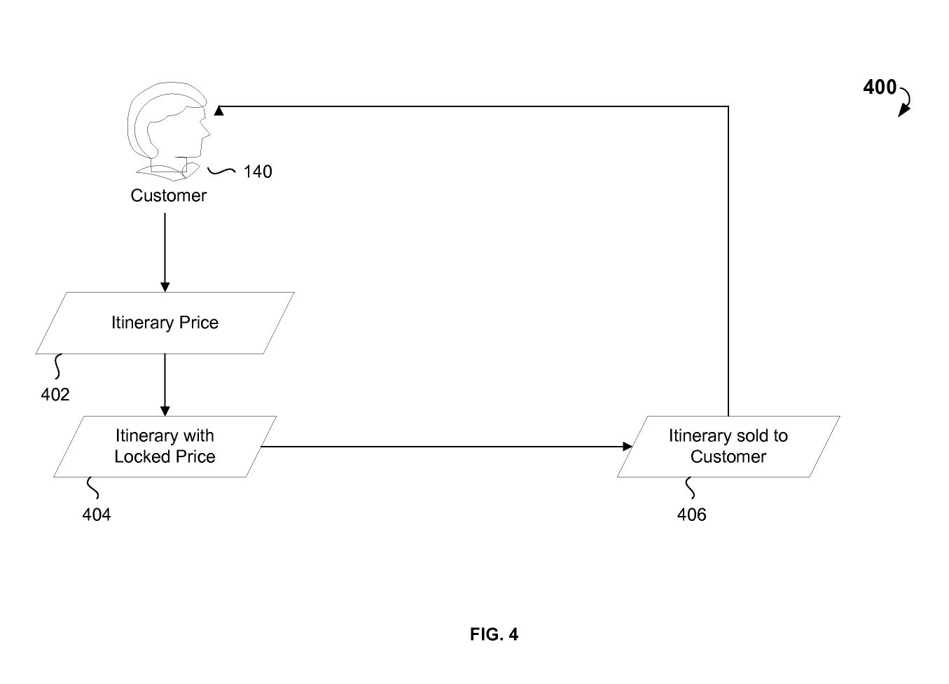

As shown in FIG. 4, when the customer 140 decides to purchase the selected itinerary, he may send a purchase request associated with the itinerary with locked price 404, which has already been purchased by the system. If the price of the selected itinerary is not yet received from the customer 140, the system 200 may collect the itinerary price 402 and finalize the sale. Then the itinerary is sold 406 to the customer 140. Thus, customers may enjoy both advantages of early bookings and associated savings, while minimizing possible losses resulting from cancellations and/modifications.

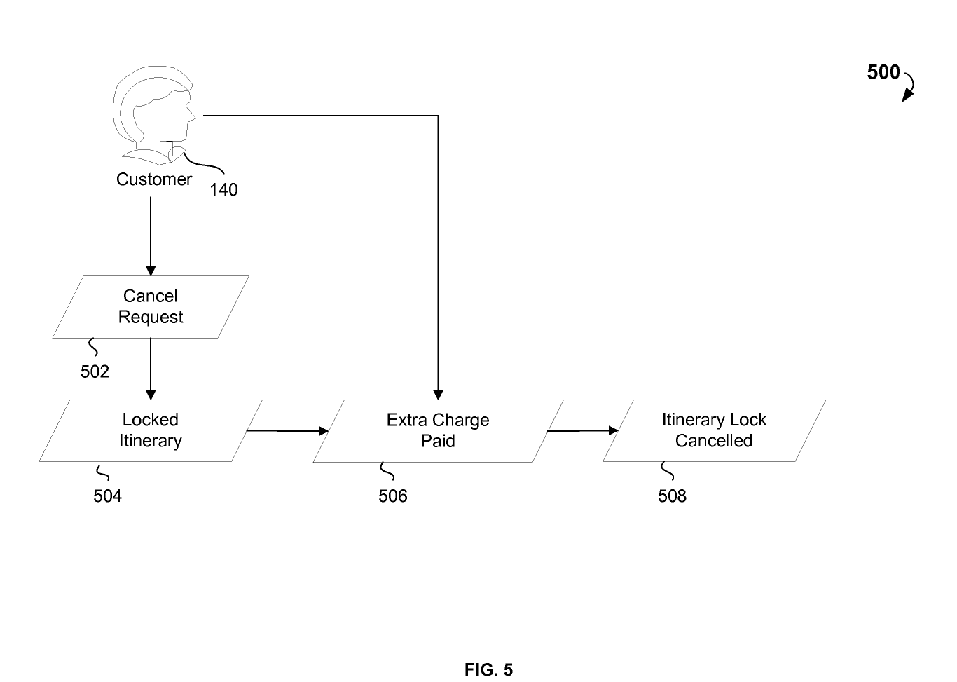

FIG. 5 shows a process 500 related to a cancellation of a locked itinerary, in accordance with some example embodiments. If the customer 140 decides to cancel the locked itinerary 504, a cancel request 502 is received. For cancellation, the customer 140 may be charged an extra charge. If the customer 140 has paid the locking payment only, he may pay an extra charge. If the price of the locked itinerary 504 was already paid by the customer 140, the price may be refunded minus the extra charge. When the extra charge is paid 506, the itinerary lock is cancelled 508. The payment for guaranteeing the price of the itinerary may not be refunded. However, the payment and the extra charge may still be smaller than the price of the itinerary. Thus, the customer 140 may have travel costs partially refunded.

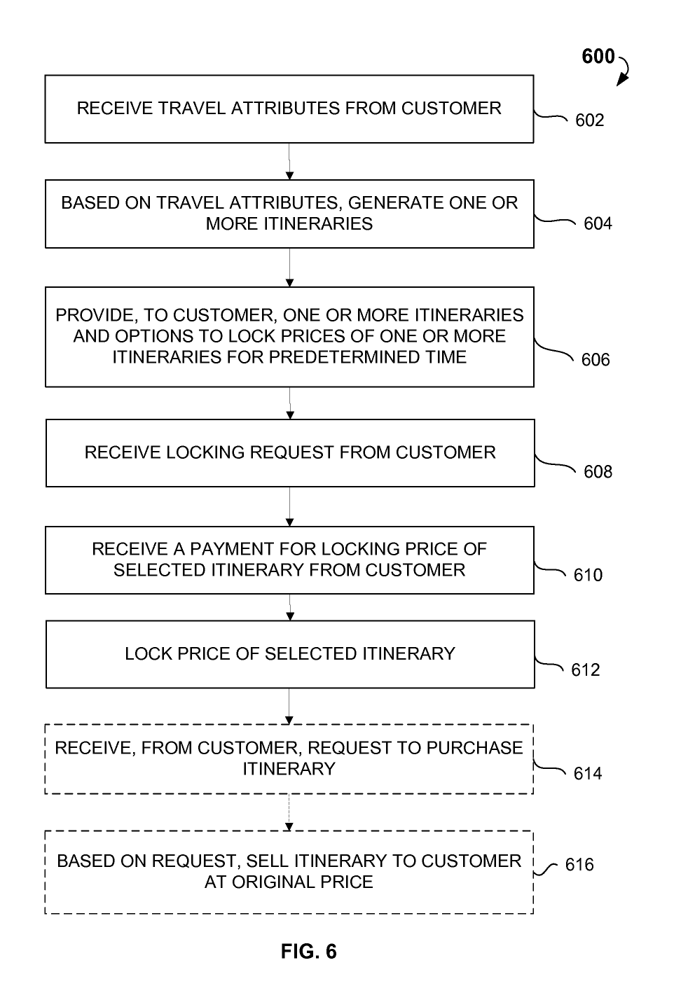

FIG. 6 is a process flow diagram showing a method for guaranteeing a price of an itinerary within the environment described with reference to FIG. 1. The method 600 may commence with receiving travel attributes from a customer at operation 602. In some cases, the travel attributes may be obtained by analyzing customer input in a text form. Additionally, travel attributes and/or additional data may be retrieved from online resources associated with the customer.

Based on the travel attributes, one or more itineraries may be generated at operation 604. The itineraries may comprise packages of travel-related items. Thus, for example, an itinerary may include flights, rental cars, transfer arrangements, hotel rooms, tourist activities, and the like.

The generated itineraries may be provided to the customer at operation 606. The itineraries may be associated with prices effective at the moment the itinerary is provided. The customer may be also provided with an option to lock the price of a selected itinerary for a predetermined time. A locking request associated with an itinerary selected by the customer may be received at operation 608. The locking request may include the period of time during which the price of the selected itinerary will be locked. The predetermined time may be specified by the customer or selected by the customer from available options.

To use the option, the customer may make a payment for locking. At operation 610, the payment for locking the price of the selected itinerary may be received from the customer. The payment may differ according to the selected period of time. For example, the payment for locking the price of the itinerary for a day may be bigger than the payment for locking the price for an hour. Upon payment, the system may purchase the itinerary at the price effective at the moment of locking. In some embodiments, the price may be charged to the customer.

Within the predetermined time, the customer may have an option to cancel or modify the itinerary. If the price is paid by the customer, it may be refunded after deduction of an extra charge for cancelling. If the customer does not use the option to cancel the itinerary within the predetermined time, the itinerary may be considered purchased by the customer. If the price of the itinerary is not paid by the customer, the price may be charged at the end of the predetermined period.

In some embodiments, a purchase request associated with the itinerary for which the price is locked may be received from the customer at operation 614. Upon on the request, the itinerary may be sold to the customer at the original price at operation 616. Additionally, the price of the itinerary and/or the payment, if not yet paid, may be received from the customer.

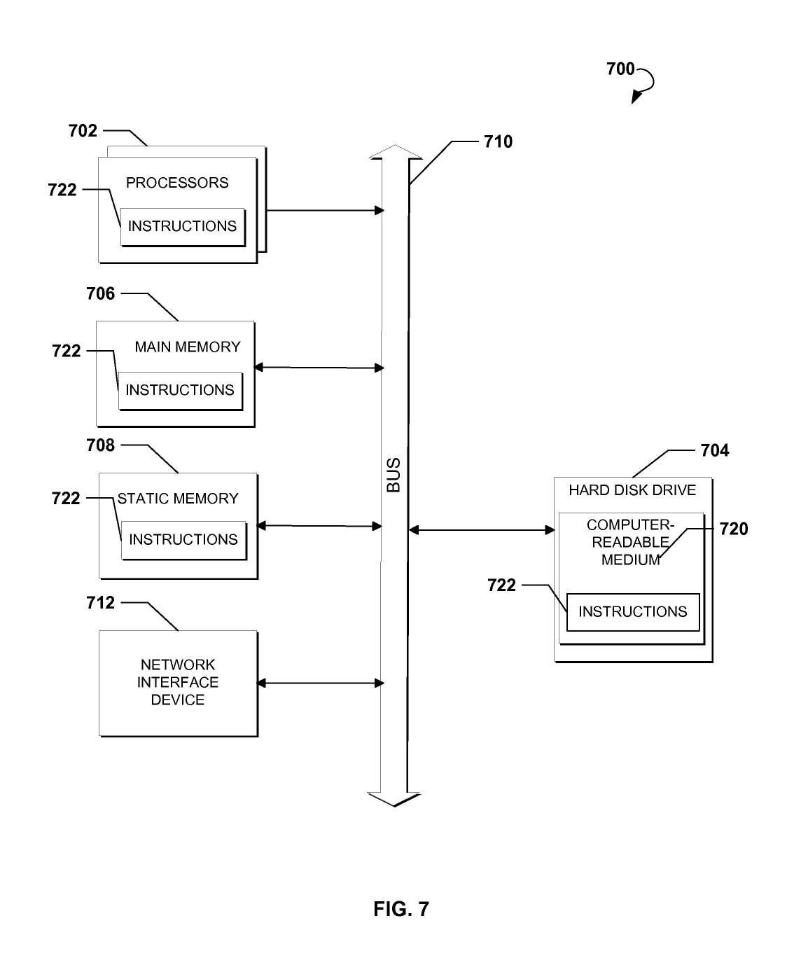

FIG. 7 shows a diagrammatic representation of a computing device for a machine in the exemplary electronic form of a computer system 700, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702, a hard disk drive 704, a main memory 706 and a static memory 708, which communicate with each other via a bus 710. The computer system 700 may also include a network interface device 712. The hard disk drive 704 may include a computer-readable medium 720, which stores one or more sets of instructions 722 embodying or utilized by any one or more of the methodologies or functions described herein. The instructions 722 can also reside, completely or at least partially, within the main memory 706 and/or within the processors 702 during execution thereof by the computer system 700. The main memory 706 and the processors 702 also constitute machine-readable media.

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, computer-implemented methods and systems for guaranteeing a price of an itinerary are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A method for guaranteeing a price of a travel itinerary, the method comprising:
receiving, by a processor, one or more travel attributes from a customer;
based on the one or more travel attributes, generating, by the processor, one or more itineraries;
providing, by the processor, to the customer, the one or more itineraries, wherein the one or more itineraries have an option to lock the price of the one or more itineraries for a predetermined period of time;
receiving, by the processor, from the customer, a locking request to lock the price of a selected itinerary from the one or more itineraries;
based on the locking request, receiving, by the processor, from the customer, a payment for locking the price of the selected itinerary; and
locking, by the processor, the price of the selected itinerary.

2. The method of claim 1, wherein the one or more travel attributes include one or more of the following: a departure date, an arrival date, a destination country, a destination city, a desired flight class, a dietary meal, a specific need, hotel preferences, and car preferences.

3. The method of claim 1, further comprising, based on the locking request, purchasing, by the processor, the selected itinerary at the price.

4. The method of claim 1, further comprising:
receiving, by the processor, a purchase request from the customer to purchase the selected itinerary;
based on the purchase request, charging the customer the price of the selected itinerary.

5. The method of claim 1, further comprising:
receiving, by the processor, a cancellation request from the customer to cancel the lock of the selected itinerary;
charging a further payment for cancelling the lock; and
based on the cancellation request, cancelling the lock.

6. The method of claim 1, further comprising providing, by the processor, a modification option to modify the selected itinerary.

7. The method of claim 6, further comprising:
receiving, by the processor, a modification request from the customer to modify the selected itinerary;
based on the locking request, receiving, by the processor, from the customer, a payment for modifying the selected itinerary;
receiving, from the customer, modifications of the itinerary; and
based on the receiving, modifying the selected itinerary.

8. The method of claim 1, further comprising storing, to a database, historical data related to the customer.

9. The method of claim 8, further comprising:
processing the historical data related to the customer to determine probability of cancellation or modification of the selected itinerary; and
based on the probability, adjusting the payment for locking the selected itinerary and the payment for modifying the selected itinerary.

10. The method of claim 8, wherein the historical data related to the customer and the historical data related to further customers are processed to adjust the payment for locking the selected itinerary and the payment for modifying the selected itinerary for the customer and for the further customers.

11. The method of claim 1, further comprising:
retrieving data related to the customer from one or more sources; and
searching for the one or more itineraries using the one or more travel attributes and the data.

12. The method of claim 11, wherein the one or more sources include one or more of the following: one or more social networks, travel history of the customer, and historical data related to the customer.

13. A system for guaranteeing a price of a travel itinerary, the system comprising:
a processor configured to:
receive one or more travel attributes from a customer;
based on the one or more travel attributes, generate one or more itineraries;
provide, to the customer the one or more itineraries, wherein the one or more itineraries have an option to lock the price of the one or more itineraries for a predetermined period of time;
receive, from the customer, a locking request to lock a the price of a selected itinerary from the one or more itineraries;
based on the locking request, receive, from the customer, a payment for locking the price of the selected itinerary; and
lock the price of the selected itinerary; and
a database in communication with the processor, the database being configured to store at least one or more travel attributes.

14. The system of claim 13, wherein the one or more travel attributes include one or more of the following: departure and arrival dates, destination country and city, desired flight class, special diet meals, special needs, hotel preferences, and car preferences.

15. The system of claim 13, wherein the processor is further configured to purchase the selected itinerary at the price based on the locking request.

16. The system of claim 13, wherein the customer purchases the selected itinerary at the price within the predetermined period of time.

17. The system of claim 13, wherein the customer cancels the locking of the selected itinerary within the predetermined period of time, the payment for locking the selected itinerary being kept by the system.

18. The system of claim 13, wherein the predetermined period of time is selected by the customer from one or more available periods, the price of the selected itinerary differing being based on the predetermined period of time selected by the customer.

19. The system of claim 13, wherein the payment for locking the selected itinerary is adjusted for the customer in accordance with historical data associated with the customer.

20. A non-transitory computer-readable medium comprising instructions, which when executed by one or more processors, perform the following operations:
receive one or more travel attributes from a customer;
based on the one or more travel attributes, generate one or more itineraries;
provide, to the customer, the one or more itineraries, wherein the one or more itineraries have an option to lock the price of the one or more itineraries for a predetermined period of time;
receive, from the customer, a locking request to lock a the price of the selected itinerary from the one or more itineraries;
based on the locking request, receive, from the customer, a payment for locking the selected itinerary; and
lock the selected itinerary.
